(19) United States
(12) Patent Application Publication
(10) Pub. No.: US 2006/0143026 A1
(43) Pub. Date: Jun. 29, 2006

(54) Network usage analysis system using cost structure and revenue and method

(76) Inventors: Srinivasan Jagannathan, Carpinteria, CA (US); Jorn Altmann, Berkeley, CA (US); Lee Rhodes, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,213

(22) Filed: Dec. 23, 2004

(51) Int. Cl. G06Q 99/00

(52) U.S. Cl. 705/1

(57) ABSTRACT

A network usage analysis system includes a data collector that is coupled to a network comprising a plurality of links over at least one selected geographic area. The data collector collects usage data corresponding to a level of use of the plurality of links, the cost of maintaining the plurality of links in the selected geographic area, and corresponding to the revenue generated from subscribers using the network in the selected geographic area. The system also includes a system server coupled to the data collector. The system server receives the usage data from the data collector and determines the economic feasibility for maintaining the network in the selected geographic area based on the subscriber usage data.

### CROSS-REFERENCE TO RELATED APPLICATIONS

This application is related to the following concurrently filed U.S. patent application Ser. No.______, Docket No. 200205880-1; ______, Docket No. 200208404-1; ______, Docket No. 200208405-1; and ______, Docket No. 200208406-1, all of which are incorporated herein by reference.

### BACKGROUND OF THE INVENTION

Network systems are utilized as communication links for everyday personal and business purposes. With the growth of network systems, particularly the Internet and wireless telephone networks, and the advancement of computer hardware and software technology, network use ranges from simple communication exchanges such as electronic mail to more complex and data intensive communication sessions such as web browsing, electronic commerce, and numerous other electronic network services such as Internet voice, and Internet video-on-demand.

Network usage information does not include the actual information exchanged in a communications session between parties, but rather includes metadata (data about data) information about the communication sessions and consists of numerous usage detail records (UDRs). The types of metadata included in each UDR will vary by the type of service and network involved, but will often contain detailed pertinent information about a particular event or communications session between parties such as the session start time and stop time, source or originator of the session, destination of the session, responsible party for accounting purposes, type of data transferred, amount of data transferred, quality of service delivered, etc. In telephony networks, the UDRs that make up the usage information are referred to as a call detail records or CDRs. In Internet networks, usage detail records do not yet have a standardized name, but in this application they will be referred to as internet detail records or IDRs. Although the term IDR is specifically used throughout this application in an Internet example context, the term IDR is defined to represent a UDR of any network.

Network usage information is useful for many important business functions such as subscriber billing, marketing and customer care, and operations management. Network usage data reporting systems are utilized for collecting, correlating, and aggregating network usage information as it occurs and creating UDRs as output that can be consumed by computer business systems that support the above business functions. Examples of these computer business systems include billing systems, marketing and customer relationship management systems, customer churn analysis systems, and data mining systems.

Especially for Internet networks, several important technological changes are key drivers in creating increasing demand for timely and cost-effective analysis of Internet usage information or the underlying IDRs.

One technological change is the dramatically increasing Internet access bandwidth at moderate subscriber cost. Most consumers today have only limited access bandwidth to the Internet via an analog telephony modem, which has a practical data transfer rate upper limit of about 56 thousand bits per second. When a network service provider's subscribers are limited to these slow rates there is an effective upper bound to potential congestion and overloading of the service provider's network. However, the increasing wide scale deployments of broadband Internet access through digital cable modems, digital subscriber line, microwave, and satellite services are increasing the Internet access bandwidth by several orders of magnitude. As such, this higher access bandwidth significantly increases the potential for network congestion and bandwidth abuse by heavy users. With this much higher bandwidth available, the usage difference between a heavy user and light user can be quite large.

Another technological change is the rapid growth of applications and services that require high bandwidth. Examples include Internet telephony, video-on-demand, and complex multiplayer multimedia games. These types of services increase the duration of time that a user is connected to the network as well as requiring significantly more bandwidth to be supplied by the service provider.

Another technological change is the transition of the Internet from “best effort” to “mission critical”. As many businesses are moving to the Internet, they are increasingly relying on this medium for their daily success. This transitions the Internet from a casual, best-effort delivery service into the mainstream of commerce. Business managers will need to have quality of service guarantees from their service provider and will be willing to pay for these higher quality services.

Network usage analysis systems provide information about how the service provider's services are being used and by whom. This is vital business information that a service provider must have in order to identify fast moving trends, establish competitive prices, and define new services or subscriber class as needed.

For reasons stated above and for other reasons presented in greater detail in the Description of the Preferred Embodiment section of the present specification, more advanced techniques are required in order to more compactly represent key usage information and provide for more timely extraction of the relevant business information from this usage information.

### SUMMARY OF THE INVENTION

The present invention is a network usage analysis system. The system includes a data collector that is coupled to a network comprising a plurality of links over at least one selected geographic area. The data collector collects usage data corresponding to a level of use of the plurality of links, the cost of maintaining the plurality of links in the selected geographic area, and corresponding to the revenue generated from subscribers using the network in the selected geographic area. The system also includes a system server coupled to the data collector. The system server receives the usage data from the data collector and determines the economic feasibility for maintaining the network in the selected geographic area based on the subscriber usage data.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram of a network usage analysis system according to the present invention providing representation of network usage information and interactive usage analysis.

FIGS. 2A and 2B illustrate networks on which the network usage analysis system performs its analysis according to the present invention.

FIG. 3 is a flow diagram illustrating one exemplary embodiment of a method for analyzing network usage using subscriber information according to the present invention.

FIG. 4 is a block diagram of an alternative embodiment a network usage analysis system according to the present invention providing representation of network usage information and interactive usage analysis.

FIG. 5 is a flow diagram illustrating one exemplary embodiment of a method for analyzing network usage according to the present invention including providing direct statistical representation of usage information, compact storage and real time interactive usage analysis.

### DESCRIPTION OF THE PREFERRED EMBODIMENTS

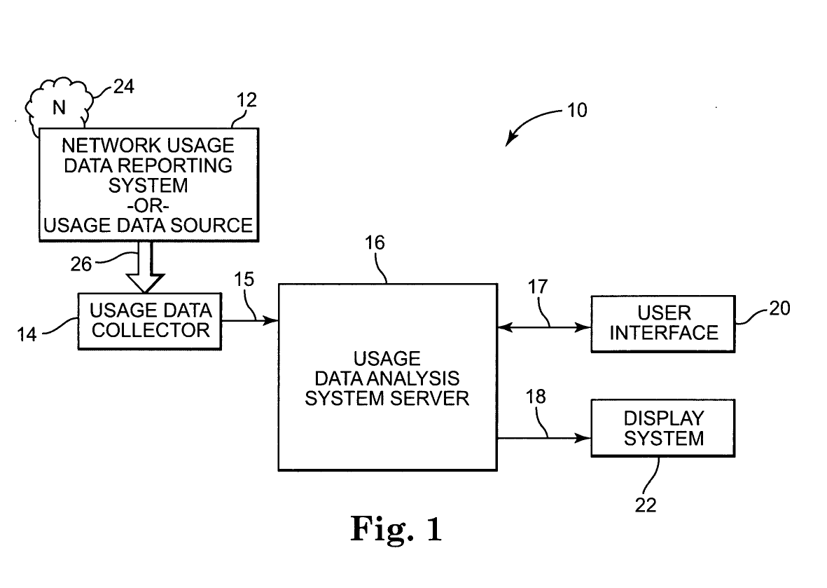

A network usage analysis system according to the present invention is illustrated generally at 10 in FIG. 1. Network usage analysis system 10 includes several main components, each of which comprises a software program. The main software program components of network usage analysis system 10 run on one or more computer or server systems. In one embodiment, each of the main software program components runs on its own computer system.

In one exemplary embodiment, network usage analysis system 10 includes a usage data collector 14, and a usage data analysis system server 16. Usage data collector 14 is coupled to usage data analysis system server 16 via communication link 15. Network usage analysis system 10 further includes user interface 20 and display system 22. User interface 20 and display system 22 are coupled to usage data analysis system server 16 via communication links 17 and 18, respectively.

Usage data collector 14 collects usage data 26. In one embodiment, the usage data 26 is a real time stream of IDRs generated from a usage data source or a network usage data reporting system 12, positioned on a network 24 (also indicated by an “N”). As used herein, a network usage data reporting system 12 is one type of usage data source. Alternatively, the IDRs may be received from a database or central data warehouse.

Usage data analysis system server 16 receives the usage data from usage data collector 14 via communication link 15. In one aspect, usage data collector 14 is separate from network usage data reporting system 12, and in another aspect, usage data collector 14 is part of a network usage data reporting system, such that the usage data analysis system server 16 receives the set of usage data directly from the network usage data reporting system. In another aspect, usage data collector 14 is part of the usage data analysis system server 16. Network 24 may be a plurality of server and host computer networks, such as the Internet, or may be a plurality of wireless networks, such as a cellular phone system.

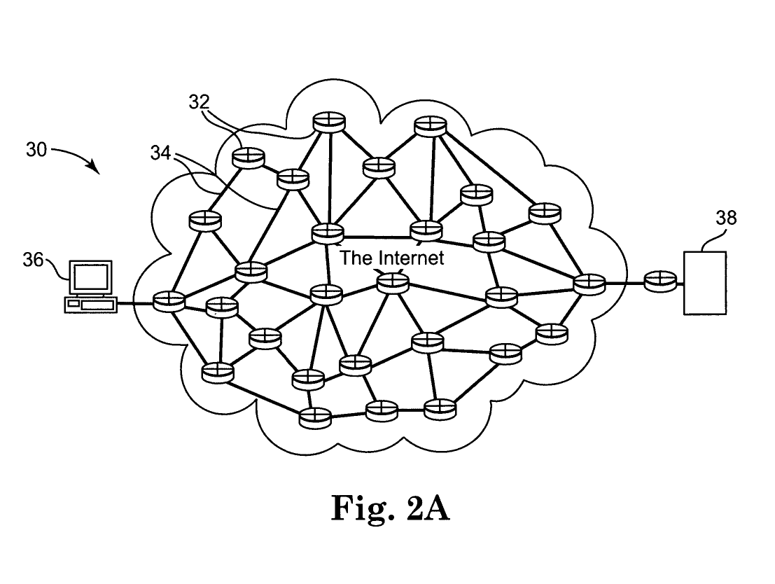

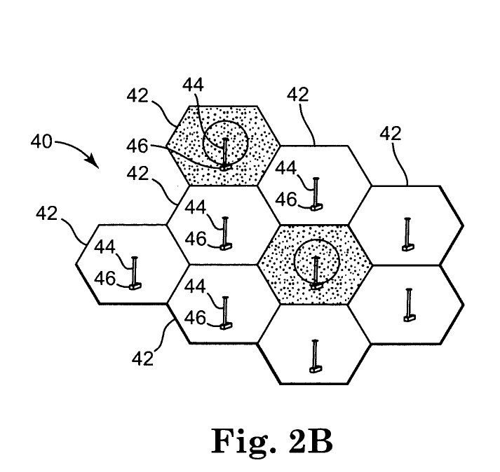

FIG. 2A illustrates an internet network 30. Internet 30 includes a plurality of routers 32 coupled to each other by a series of links 34. An access computer 36 and a host computer 38 are illustrated coupled to the network 30. Routers 32 determine the links 34 used to connect access computer 36 to host computer 38. There are many options of various links 34 that can be used to connect access computer 36 to host computer 38. Data, whether in the form of a web-page, a downloaded file or an e-mail message, travels over internet 30 as a packet-switching network system. In this system, the data in a message or in a file is broken up into packages, each about over 1,000 bytes long. Each of these packages gets a wrapper that includes information on the sender's address, the receiver's address, the package's place in the entire message, and how the receiving computer can be sure that the package arrived intact. Each data package, called a packet, is then sent off to its destination via the best available route—a route that might be taken by all the other packets in the message or by none of the other packets in the message. In other words, routers 32 may send packets from the same message or file over different links 34 to eventually arrive at the same destination.

For example, if there is a problem with one piece of equipment in internet 30 while a message is being transferred, packets can be routed around the problem, ensuring the delivery of the entire message. Routers 32 that make up the main part of internet 30 can reconfigure links 34, or the paths, that packets take because they look at the information surrounding the data packet, and they tell each other about line conditions, such as delays in receiving and sending data and traffic on various pieces of the network. Consequently, some links 34 of network 30 may be more used than other links for sending packets.

FIG. 2B illustrates a wireless network 40. Wireless network 40 includes a plurality of cells 42, each of which include a tower 44 and associated transmission equipment 46 for sending and receiving signals. Although wireless network 40 differs in operation from internet 30, it similarly bundles and transmits data in packets that are transferred from tower 44 to tower 44 from a source to a destination. Again, the route or path that the packets take can differ, and some cells 42, or links, may be more used than others.

Usage analysis system 10 is used in association with networks such as networks 30 and 40 illustrated in FIGS. 2A and 2B. Usage data source 12 receives usage data 26 and passes usage data 26 to usage data collector 14. Usage data analysis system server 16 then receives and uses usage data 26 to perform analysis on the usage data 26. In addition to the type of service and network involved, information about a particular event or communications session between parties such as the session start time and stop time, source or originator of the session, destination of the session, responsible party for accounting purposes, type of data transferred, amount of data transferred, quality of service delivered, the usage data 26 in the present invention also includes geographic-specific information about the most popular routes, the costs to maintain those routes, and actual revenue generated from subscribers using those routes. Consequently, usage data analysis system server 16 can monitor geographic areas selected by a user, analyze the popular routes in this selected geographic area and determine whether the pricing in that area is viable or whether a new cost-effective plan must be established.

In one embodiment, usage analysis system 10 is used to make business decisions about network 24 based on consideration of a selected geographic location covered by network 24, consideration of the routes in this selected geographic area, consideration of the costs of maintaining routes in the selected geographic area, the revenue generated from subscribers using network 24 in the selected geographic area, and the viability of the pricing plan in the selected geographic area. Business decisions, such as a modification to the pricing plan for access to network 24 or elimination of service in certain geographic areas, can be based on an analysis of the routes in this selected geographic area, consideration of the costs of maintaining routes in the selected geographic area, and the revenue generated from subscribers using network 24 in the selected geographic area.

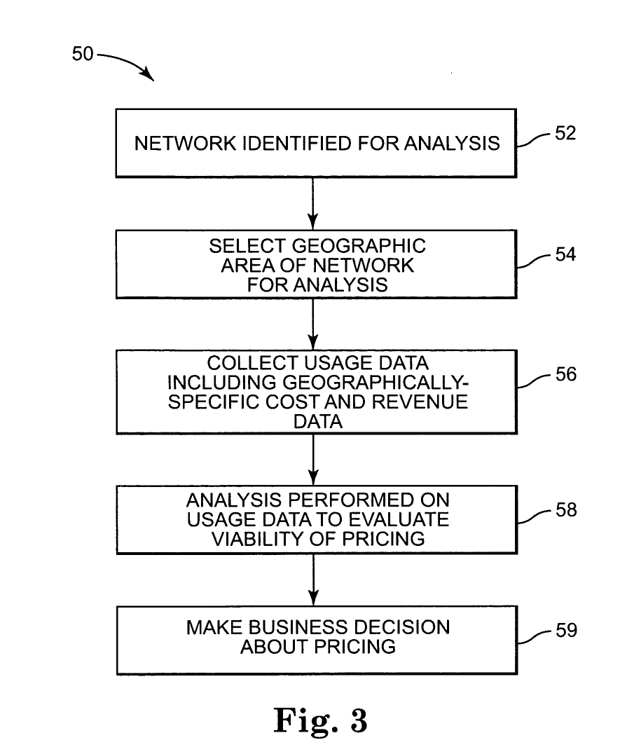

In FIG. 3, a flow diagram illustrating one exemplary embodiment of a method for analyzing network usage according to the present invention is shown generally at 50. Reference is also made to FIGS. 1, 2A and 2B. In step 52, a network 24 is identified for analysis. In step 54, a geographical area of network 24 is selected for analysis. In one embodiment, a user may be prompted to select a geographic area to be evaluated. In this way, analysis of network usage can be tailored to any particular selected geographic area.

In step 56, usage data is collected from the network for analysis. The type of usage data collected is that which can be generated from a network usage data reporting system or a usage data source 12. In one exemplary embodiment, the usage data 26 consists of a real time or real time stream of IDRs received from a network usage data reporting system. The usage data collector 14 collects usage data from the IDRs that may include the type of service and network involved, information about a particular event or communications session between parties such as the session start time and stop time, source or originator of the session, destination of the session, responsible party for accounting purposes, type of data transferred, a usage metric (e.g., bandwidth, megabytes, time), amount of data transferred, quality of service delivered, routes used in a geographic area, cost of maintaining routes used in a geographic area, cost of maintaining routes in a geographic area, and revenue generated from subscribers using routes in a geographic area. When the user has selected a particular geographic area for analysis, usage data 26 will include routes used in the selected geographic area, cost of maintaining routes used in the selected geographic area, and revenue generated from subscribers using routes in the selected geographic area.

In step 58, the collected usage data 26 is analyzed in order to evaluate the viability of pricing in the selected geographic area. The analysis includes determining the most popular routes or links of network 24 that are used by subscribers in the selected geographic area, as well as the cost of maintaining these routes or links. This information can then be compared to the calculated revenue generated from subscribers using these routes or link of network 24 in the selected geographic area. This comparison will determine whether the pricing plan used by the network service provider in generating the revenue is viable or whether it could be improved.

In step 59 a business decision is made about the pricing of network services based on the viability of the pricing plan. For example, usage analysis system 10 can be used by a network service provider to determine the viability of a pricing plan for subscribers in the San Francisco area. After the user of the system select San Francisco, the usage data is analyzed and it is determined that the monthly costs incurred in transmitting data for the San Francisco subscribers is $X. Furthermore, the usage data is analyzed and it is determined that the monthly revenue generated from the San Francisco subscribers is $Y. When X is less than Y, the pricing plan in San Francisco is viable because it is profitable based on the analysis of the usage data. When X is grater than Y, however, the pricing plan in San Francisco is not viable because the service provider is loosing money with the plan. Consequently, under these circumstances the pricing plans would need to be modified to achieve profitability. If the rates cannot be increased in the applicable selected area, it may be determined that the market is not viable.

Usage analysis system 10 accomplishes optimization of network resources in the form of viability assessment of pricing plans that is specifically tailored to a geographic region. With prior systems, business decisions such as evaluating pricing plans of network services were made by only generally monitoring the overall network, and could not achieve such tailored optimization.

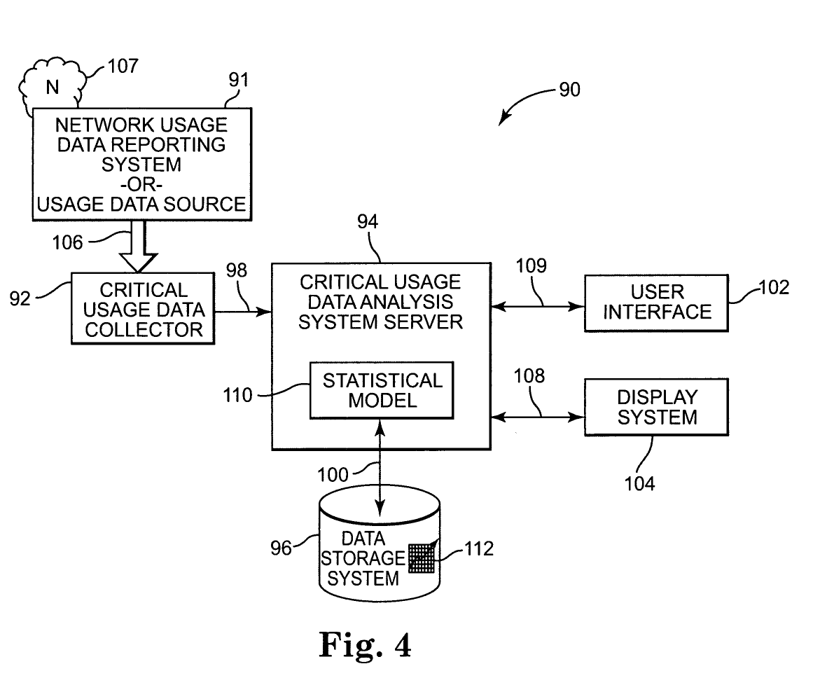

In another embodiment of the present invention, illustrated in FIG. 4, network usage analysis system 90 provides direct statistical representation of usage information and provides compact storage and real time, interactive usage analysis. The network usage analysis system 90 in accordance with the present invention provides for the use of statistical models and the storage of statistical data representative of critical usage data in lieu of storing the critical usage data, thereby allowing for real time interactive statistical analysis and greatly reducing usage data storage requirements. Since statistical models are stored and not the usage data itself, with the present invention the storage requirements do not grow with the amount of usage data. The storage requirements for the statistical models are a function of the complexity of the business to be modeled and the granularity of the desired results.

In one exemplary embodiment, network usage analysis system 90 includes a critical usage data collector 92, a critical usage data analysis system server 94 and a data storage system 96. Critical usage data collector 92 is coupled to critical usage data analysis system server 94 via communication link 98. Data storage system 96 is coupled to critical usage data analysis system server 94 via communication link 100. Network usage analysis system 90 further includes user interface 102 and display system 104. User interface 102 and display system 104 are coupled to critical usage data analysis system server 94 via communication links 109 and 108 respectively.

Critical usage data collector 92 collects critical usage data (e.g., a set of critical usage data) from usage data 106. Preferably, the usage data 106 is a real time stream of network usage data records. In one embodiment, the usage data 106 is a real time stream of IDRs generated from a usage data source or a network usage data reporting system 91, positioned on a network 107 (also indicated by an “N”). As used herein, a network usage data reporting system 90 is one type of usage data source. Alternatively, the IDRs may be received from a database or central data warehouse.

One network usage data reporting system suitable for use with the present invention is commercially available under the tradename SMART INTERNET USAGE 2.01 (SIU 2.01), from Hewlett-Packard, U.S.A. Other network usage data reporting systems suitable for use with the usage analysis system in accordance with the present invention will become apparent to those skilled in the art after reading the present application.

Usage data analysis system server 94 receives the critical usage data from the critical usage data collector 92 via communication link 98. In one aspect, the critical usage data collector 92 is separate from a network usage data reporting system, and in another aspect, the critical usage data collector 92 is part of a network usage data reporting system, such that the critical usage data analysis system server 94 receives the set of critical usage data directly from the network usage data reporting system. In another aspect, the critical usage data collector 92 is part of the critical usage data analysis system server 94.

The critical usage data analysis system server 94 uses the set of critical usage data to perform predetermined network usage statistical analysis. In particular, a statistical model 110 is defined for solving a network usage related business problem. The critical usage data analysis system server 94 uses the critical usage data and the statistical model 110 to generate statistical data 112. The critical usage data analysis system server 94 operates to store the statistical data 112 in the data storage system 96. In one aspect, the statistical data is stored in the form of a table (e.g., a distribution table).

After storage of the statistical model 110, the set of critical usage data is no longer retained. In one aspect, the critical usage data analysis system server 94 is responsive to the user interface 102 for interactive analysis of the statistical model 110. Further, a graphical display of the statistical model 110 can be output to display system 104. One exemplary embodiment of interactive analysis of critical usage data using the statistical model 110 is described in related application INTERNET USAGE ANALYSIS SYSTEM AND METHOD, Ser. No. 09/548,124, filed Apr. 12, 2000, which is incorporated by reference herein.

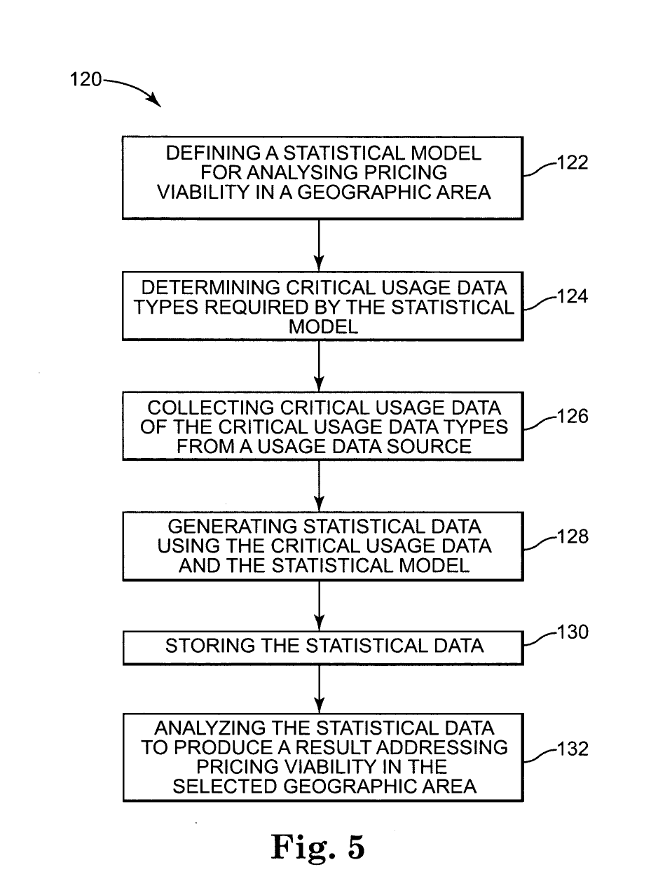

In FIG. 5, a flow diagram illustrating one exemplary embodiment of a method for analyzing network usage according to the present invention is shown generally at 120. Reference is also made to FIG. 5. In step 122, a statistical model is defined for solving a network usage related business problem, such as evaluating the viability of a pricing plan in a selected geographic area. Such decision can be based on an analysis of the routes in this selected geographic area, consideration of the costs of maintaining routes in the selected geographic area, and the revenue generated from subscribers using network 24 in the selected geographic area.

In step 124, critical usage data types required by the statistical model are determined. The type of statistical model chosen is based on the network usage related business problem to be solved. By defining only critical usage data types required by the statistical model, the volume of usage data that needs to be collected is greatly reduced. For example, the critical usage data may be a selected geographic area, costs of maintaining routes in the selected geographic area, and revenue generated from subscribers using those routes in the selected geographic area.

In step 126, critical usage data 98 of the critical usage data types are collected from usage data 106 that can be generated from a network usage data reporting system or a usage data source 91. In one exemplary embodiment, the usage data 106 consists of a real time or real time stream of IDRs received from a network usage data reporting system. A real time stream of IDRs is defined as a stream of IDRs that is “flushed” or transferred from a data storage location at regular and frequent intervals (e.g., which may be substantially instantaneous or, based on the usage data source, from seconds to minutes). The critical usage data collector 92 collects critical usage data from the IDRs that may actual usage by subscribers of particular network links and relative importance of those subscribers.

In step 128, statistical data representative of the critical usage data are generated. In particular, statistical data are generated using the critical usage data and the statistical model. The step of generating the statistical data can be done in real time.

In step 130, the statistical data are stored. The statistical data may be stored in various forms, such as in the form of a table or graph in volatile or nonvolatile memory. After storing of the statistical data, the critical usage data can be deleted, since it is not necessary to retain it for the selected network usage related business problem. As such, storing of the statistical data representative of the collected critical usage data in lieu of storing the critical usage data itself greatly reduces data storage requirements.

In step 132, the statistical data can be analyzed to produce a result addressing the network usage related business problem. Also, the statistical data may be stored in volatile memory (e.g., RAM) to provide for interactive analysis and presentation of results pertinent to a network usage related business problem. The statistical data may be stored and/or archived in non-volatile memory, such as a hard disk drive. In particular, the statistical model is used to determine/analyze usage characteristics. The statistical model may also be used for performing interactive analysis of the critical usage data via user interface 102. In particular, the statistical model may include one or more variable elements, wherein the variable elements are changeable via user interface 102 to interactively model network usage. The statistical model results can be graphically or otherwise displayed using display system 104.

For example, a user can be prompted via display system 104 to select a geographical area to be analyzed. Once a particular geographic region is selected, the critical usage data may be a selected geographic area, costs of maintaining routes in the selected geographic area, and revenue generated from subscribers using those routes in the selected geographic area.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method for analyzing network usage comprising the steps of:
analyzing a network comprising a plurality of network links distributed over a plurality of geographic areas;
selecting a geographic area of the network;
collecting subscriber usage data from the plurality of network links for the selected geographic area, the subscriber usage data indicative of usage of each of the plurality of network links for the selected geographic area; and
determining an economic feasibility for maintaining the network in the selected geographic area based on the subscriber usage data.

2. The method of claim 1, further comprising generating statistical data from the collected subscriber usage data using a statistical model comprising at least one of a histogram, an ordered histogram, a probability density function and a cumulative probability distribution function and determining an economic feasibility for maintaining the network in the selected geographic area based on the generated statistical data.

3. The method of claim 2, further comprising storing only the statistical data.

4. The method of claim 2, further comprising deleting the subscriber usage data after storing the statistical data.

5. The method of claim 2, further comprising collecting a second set of usage data and updating the statistical data using the second set of critical usage data.

6. The method of claim 2, wherein generating the statistical data comprises generating the statistical data in real time.

7. The method of claim 1, wherein determining the economic feasibility for maintaining the network in the selected geographic includes consideration of both costs to maintain the plurality of network links in the selected geographic area and actual revenue generated from subscribers using the plurality of network links in the selected geographic area.

8. The method of claim 7, further comprising changing a pricing plan for the selected geographic area when the costs to maintain the plurality of network links in the selected geographic area exceed the actual revenue generated from subscribers using the plurality of network links in the selected geographic area.

9. The method of claim 2, further comprising using the statistical model to perform interactive analysis of the usage data.

10. The method of claim 1, wherein determining the economic feasibility for maintaining the network in the selected geographic area includes determining the economic feasibility for maintaining the network in the selected geographic area in real time.

11. The method of claim 1, wherein analyzing a network comprises analyzing a network as an Internet network.

12. The method of claim 1, wherein analyzing a network comprises analyzing a network as a wireless telephone network.

13. A network usage analysis system comprising:
a data collector coupled to a network comprising a plurality of links in a selected geographic area, wherein the data collector collects subscriber usage data corresponding to the cost of maintaining the plurality of links in the selected geographic area and corresponding to the revenue generated from subscribers using the network in the selected geographic area; and
a system server coupled to the data collector, wherein system server receives the subscriber usage data from the data collector and calculates whether pricing for the selected geographic area is feasible based on a cost of maintaining the plurality of links in the selected geographic area and on a revenue generated from subscribers using the network in the selected geographic area.

14. The system of claim 13, wherein the system server generates statistical data based on the usage data and on a predefined statistical model comprising at least one of a histogram, an ordered histogram, a probability density function and a cumulative probability distribution function and the system server calculates whether pricing for the selected geographic area is feasible based on the generated statistical data.

15. The system of claim 14, further comprising a data storage system for storing only the statistical data.

16. The system of claim 14, wherein the system server updates the statistical data using additionally collected usage data.

17. The system of claim 15, wherein the data storage system includes random access memory.

18. The system of claim 15, wherein the data storage system includes a hard disk drive or other persistent storage device.

19. The system of claim 14, further comprising a user interface operably coupled to the system server wherein a user selects a geographic area with the user interface.

20. The system of claim 19, wherein the system server is responsive to the user interface for interactive analysis of the statistical model.

21. The system of claim 14, further comprising a display system for displaying the statistical model.

22. The system of claim 14, wherein the statistical model is in the form of a table.

23. The system of claim 14, wherein the table is a distribution table.

24. The system of claim 13, wherein the network is an Internet network.

25. The system of claim 13, wherein the network is a wireless telephone network.

26. A method for analyzing network usage, including making business decisions for a network service provider, the method comprising the steps of:
analyzing a network comprising a plurality of network links covering a plurality of geographic areas;
selecting a particular geographic area having a plurality of links;
collecting subscriber usage data from the plurality of links in the particular selected geographic area;
calculating a cost of maintaining the plurality of links in the particular geographic area;
calculating a revenue generated from subscribers using the network in the particular geographic area; and
calculating an economic feasibility for maintaining the network in the particular geographic area.

27. The method of claim 26, wherein calculating the economic feasibility for maintaining the network in the particular geographic includes consideration of the difference between the cost of maintaining the plurality of links in the particular geographic area and the revenue generated from subscribers using the network in the particular geographic area.

28. The method of claim 26, further including revising a pricing structure of the network based on the calculated economic feasibility.

29. The method of claim 26, further comprising generating statistical data from the collected subscriber usage data using a statistical model comprising at least one of a histogram, an ordered histogram, a probability density function and a cumulative probability distribution function and calculating the economic feasibility for maintaining the network in the particular geographic area from the generated statistical data.

30. The method of claim 29, further comprising storing only the statistical data.

31. The method of claim 30, further comprising collecting a second set of usage data and updating the statistical data using the second set of critical usage data.

32. The method of claim 30, wherein storing the statistical data comprises storing the statistical data in a table.

33. The method of claim 30, further comprising deleting the subscriber usage data after storing the statistical data.

34. The method of claim 28, wherein generating the statistical data comprises generating the statistical data in real time.

35. The method of claim 28, further comprising using the statistical model to perform interactive analysis of the usage data.

36. The method of claim 26, wherein determining the economic feasibility for maintaining the network in the selected geographic area includes determining the economic feasibility for maintaining the network in the selected geographic area in real time.

37. The method of claim 26, wherein analyzing a network comprises analyzing a network as an Internet network.

38. The method of claim 27, wherein analyzing a network comprises analyzing a network as a wireless telephone network.

39. A computer readable medium containing instructions for controlling a computer system to perform a method for analyzing network usage comprising the steps of:
analyzing a network comprising a plurality of network links;
selecting a geographic region of the network having a plurality of network links in the geographic region;
collecting subscriber usage data from the plurality of network links in the selected geographic region, the usage data indicative of cost and revenue of each of the plurality of network links in the selected geographic region; and
calculating an economic feasibility for maintaining the network in the selected geographic region.

40. The computer readable medium of claim 39, further comprising generating statistical data from the collected subscriber usage data using a statistical model comprising at least one of a histogram, an ordered histogram, a probability density function and a cumulative probability distribution function and calculating the economic feasibility for maintaining the network in the particular geographic area from the generated statistical data.

41. The computer readable medium of claim 40, further comprising storing only the statistical data.
